(19) United States
(12) Patent Application Publication
(10) Pub. No.: US 2014/0252237 A1
(43) Pub. Date: Sep. 11, 2014

(54) METHODS OF DETECTING THE PRESENCE OF MICROORGANISMS IN A SAMPLE

(71) Applicant: D.I. R. TECHNOLOGIES (DETECTION IR) LTD., Haifa (IL)

(72) Inventors: Yoav Weinstein, Atlit (IL); Eran Sinbar, Shorashim (IL)

(21) Appl. No.: 14/350,780

(22) PCT Filed: Oct. 15, 2012
(86) PCT No.: PCT/IL2012/050405

§ 371 Date: Apr. 9, 2014

Related U.S. Application Data
(60) Provisional application No. 61/547,807, filed on Oct. 17, 2011.
(60) Provisional application No. 61/680,797, filed on Aug. 8, 2012.

(51) Int. Cl. G01N 21/55; G01N 21/59

(52) U.S. Cl. CPC G01N 21/55; G01N 21/59
USPC 250/341.8

(57) ABSTRACT

The present disclosure provides a method of detecting the presence of a microorganism in a tested sample, the method comprises:
illuminating the tested sample; and
generating one or more infrared (IR) images of the sample using an IR detector operable to detect, in its field of view, radiation reflected and/or transmitted from the test sample in the IR spectral region of 0.75 to 20 μm or spectral region therein;
wherein the radiation, imaged in the one or more IR images, is indicative of the presence of a microorganism in the test sample.

The method according to the present disclosure is utilized in determining the efficiency of an anti-microbial agent.

### FIELD OF THE INVENTION

This invention relates to methods of detecting the presence of microorganisms in a sample.

### BACKGROUND OF THE INVENTION

The detection of pathogenic microorganism is essential in assuring health and safety. Legislation is particularly tough in areas such as the food and drug industry. In spite of the real need for obtaining analytical results in the shortest time possible, traditional and standard bacterial detection methods may take several days to yield a reliable answer. Therefore, many attempts are made in the research arena to develop rapid methods for detection.

One such rapid detection method makes use of thermography, where radiation emitted from a material is imaged and analyzed. For example, U.S. Patent Application Publication No. 2010/0311109 describes a method for quantifying an amount of a viable microorganism in a fluid sample, the method comprises subjecting the fluid sample suspected of containing a viable microorganism to a temperature change, and correlating the temperature history of the fluid sample to the amount of the viable microorganism contained in the fluid sample. The temperature change may be determined by acquiring a plurality of sequential thermal images such as infrared thermography images.

### SUMMARY OF THE DISCLOSURE

The present disclosure is based on the finding that under specific conditions microorganisms such as bacterial colonies may be detected in samples by utilizing infra red (IR) imaging. The inventors of the present disclosure have surprisingly found that subjecting the microorganism containing sample to illumination and capturing, in one or more IR regions IR images of the samples provided indication of presence of microorganisms in the samples. The one or more regions are particularly selected from near-infrared region (NIR), short wave IR region (SWIR), mid wave IR region (MWIR), long wave IR region (LWIR) and very long wave IR region (VLWIR).

Thus, in one of its aspects the present disclosure provides a method of detecting the presence of a microorganism in a tested sample, the method comprises:
illuminating the tested sample; and
generating one or more infrared (IR) images of the sample using an IR detector operable to detect, in its field of view, radiation reflected and/or transmitted from the test sample in the IR spectral region of 0.75 to 20 μm or spectral region therein;

wherein said radiation, imaged in the one or more IR images, is indicative of the presence of a microorganism in the test sample.

In another one of its aspects the present disclosure provides a method of determining the efficiency of an anti-microbial agent against a microorganism, the method comprises:
providing at least two samples comprising a microorganism against which the efficiency of an agent is to be determined, at least one of the at least two samples being a control sample and at least one of the at least two samples being a test sample;
contacting the test sample with an amount of an agent;
illuminating the at least two samples; and
generating one or more IR images of each sample using an IR detector operable to detect, in its field of view, radiation reflected and/or transmitted from the test sample in a spectral region within 0.75 to 20 μm, wherein a difference between the one or more IR images of the test sample and the one or more IR images of the control sample being indicative that the agent affects the microorganism.

### DETAILED DESCRIPTION OF THE DISCLOSURE

In one of its aspects the present disclosure provides a method of detecting presence of a microorganism in a tested sample, the method comprises generating one or more infrared images of the sample using an IR detector operable to detect, in its field of view, radiation reflected and/or transmitted from the test sample in the IR spectral region of 0.75 to 20 μm or spectral region therein; wherein said radiation reflected and/or transmitted from the sample and imaged in the one or more infrared images is indicative of a presence of a microorganism in the test sample.

In another one of its aspects the present disclosure provides a method of detecting presence of a microorganism in a tested sample, the method comprises generating one or more infrared images of the sample using an IR detector operable to detect, in its field of view, radiation reflected and/or transmitted from the test sample in a spectral region selected from 0.75-5 μm, 5-8 μm, 8-12 μm, 12-20 μm and any combination of the same; wherein said radiation reflected and/or transmitted from the sample and imaged in the one or more infrared images is indicative of a presence of a microorganism in the test sample.

In yet another one of its aspects the present disclosure provides a method of detecting presence of a microorganism in a tested sample, the method comprises:
illuminating the tested sample; and
generating one or more infrared images of the sample using an IR detector operable to detect, in its field of view, radiation reflected and/or transmitted from the test sample in the IR spectral region within 0.75 to 20 μm;

wherein radiation reflected and/or transmitted from the sample and imaged in the one or more infrared images is indicative of a presence of a microorganism in the test sample.

Yet in another one of its aspects the present disclosure provides a method of detecting presence of a microorganism in a tested sample, the method comprises:
illuminating the tested sample; and
generating one or more infrared images of the sample using an IR detector operable to detect, in its field of view, radiation reflected and/or transmitted from the test sample in a spectral region selected from 0.75-5 μm, 5-8 μm, 8-12 μm, 12-20 μm and any combination of the same;

wherein radiation reflected and/or transmitted from the sample and imaged in the one or more infrared images is indicative of a presence of a microorganism in the test sample.

In yet another one of its aspects the present disclosure provides a method of detecting presence of a microorganism in a tested sample, the method comprises:
illuminating the tested sample; and
generating one or more infrared images of the sample using an IR detector operable to detect, in its field of view, radiation reflected and/or transmitted from the test sample in a spectral region of 1-5 μm;

wherein radiation reflected and/or transmitted from the sample and imaged in the one or more infrared images is indicative of a presence of a microorganism in the test sample.

Yet in a farther one of its aspects the present disclosure provides a method of detecting presence of a microorganism in a tested sample, the method comprises:
illuminating the tested sample, and
generating one or more infrared images of the sample using an IR detector operable to detect, in its field of view, radiation reflected and/or transmitted from the test sample in a spectral region of 1-3 μm;

wherein radiation reflected and/or transmitted from the sample and imaged in the one or more infrared images is indicative of a presence of a microorganism in the test sample.

In some embodiments the sample is imaged at ambient temperature (e.g., 25° C.)

In some embodiments the sample is illuminated and imaged at ambient temperature (e.g., 25° C.).

In some embodiments the sample may be cooled to temperature below ambient temperature (e.g., 20° C., 15° C.) prior to illuminating and imaging thereof.

The microorganism may be of any type known in microbiology, including, without being limited thereto, bacterium, fungus, archaea, protists, prion, protozoa and spores. In some embodiments the microorganism may be a virus. In some further embodiments the microorganisms may be a parasite such as virus and bacterium.

In some embodiments the microorganism is of a type that would require detection in a sample, such as a disease causing pathogen. Such pathogens may include, without being limited thereto, viruses, bacteria, fungi and protozoa.

Further examples for microorganisms are provided below with respect to various possible uses of the methods of the invention.

The tested sample may be provided in the form of a liquid sample, e.g. in a test tube or the tested sample may be provided on a solid substrate, such as on a culture dish, for example, an agar (agarose gel) Petri dish.

In some embodiments the reflected radiation and/or transmitted radiation may be detected in the spectral region of 0.75-1.4 μm, also known as the near-infrared (NIR) spectral region.

In some embodiments the radiation detected from the sample (i.e., radiation reflected and/or transmitted) is in a spectral region of 1-3 μm, also known as the short wave IR (SWIR) spectral region.

In some embodiments the reflected radiation and/or transmitted radiation may be detected in the spectral region of 1.4-3 μm, at times in the spectral region of 1-1.7 μm.

In a preferred embodiment the radiation reflected and/or transmitted from the test sample is in the spectral region of 1-5 μm.

In some embodiments the radiation reflected and/or transmitted from the test sample is in the spectral region of 3-5 μm also known as the mid wave IR (MWIR) spectral region.

In some embodiments the radiation reflected and/or transmitted from the test sample is in the mid wave IR spectral region of 5-8 μm.

In some embodiments the radiation reflected and/or transmitted from the test sample is in the spectral region of 8-12 μm or 7-14 μm also known as the long wave IR (LWIR) spectral region.

In some embodiments the radiation reflected and/or transmitted from the test sample is in the spectral region of 8-15 μm.

In some embodiments the radiation reflected and/or transmitted from the test sample is in the spectral region of 12-20 μm also known as the very long wave IR spectral region (VLWIR).

In some embodiments, the radiation reflected and/or transmitted may be detected in a wavelength range or at one or more specific wavelengths. The selection of a particular wavelength region or specific wavelength may be achieved using one or more specific IR filters.

When illumination is involved, the IR images are acquired while the tested sample is illuminated. Illumination may be performed using one or more light sources selected from the group consisting of halogen light, ultra violate (UV) light, visible light, electric bulb (“white light”), IR light (red IR light) and any combination of the same, without being limited thereto.

In some embodiments the illumination light source is a red/infrared heat lamp (e.g., 100 Watt). In some embodiments the red/infrared heat lamp radiates at least in one of the spectral regions selected from visible, NIR, SWIR, MWIR, LWIR and VLWIR.

In some embodiments the illumination light source is halogen bulb. In some embodiments the halogen bulb radiates in the spectral regions selected from NIR, SWIR or both.

The illumination of the sample may be by using a continuous light beam or a continuous string of light pulses. Without being limited thereto, the direction of the light from the light source to the sample may include any illumination side e.g., light from any direction, including upper light, side light and backlight. In some embodiments the illumination is a dark field illumination. In some further embodiments the illumination is by movable light.

In some embodiments the sample is illuminated with visible light and radiation is detected and imaged at the spectral region of 0.75-5 μm, more specifically, at the spectral region of 1-5 μm, even more specifically, at the spectral region of 1-3 μm, at times at the spectral region of 3-5 μm and even at times at the spectral region of 0.75-1.4 μm.

In some embodiments the sample is illuminated with visible light and radiation is detected and imaged at the spectral region of 5-8 μm.

In some embodiments the sample is illuminated with visible light and radiation is detected and imaged at the spectral region of 8-15 μm, at times at the spectral region of 8-12 μm, even at times at the spectral region of 7-14 μm.

In some embodiments the sample is illuminated with visible light and radiation is detected and imaged at the spectral region of 12-20 μm.

In some embodiments the sample is illuminated with red IR light and radiation is detected and imaged at the spectral region of 0.75-5 μm, more specifically, at the spectral region of 1-5 μm, even more specifically, at the spectral region of 1-3 μm, at times at the spectral region of 3-5 μm and even at times at the spectral region of 0.75-1.4 μm).

In some embodiments the sample is illuminated with red IR light and radiation is detected and imaged at the spectral region of 5-8 μm.

In some embodiments the sample is illuminated with red IR light and radiation is detected and imaged at the spectral region of 8-15 μm, at times at the spectral region of 8-12 μm, even at times at the spectral region of 7-14 μm.

In some embodiments the sample is illuminated with red IR light and radiation is detected and imaged at the spectral region of 12-20 μm.

In some embodiments the sample is illuminated with halogen light and radiation may be detected and imaged at the spectral region of 0.75-5 μm, more specifically, at the spectral region of 1-5 μm, even more specifically, at the spectral region of 1-3 μm, at times at the spectral region of 3-5 μm and even at times at the spectral region of 0.75-1.4 μm.

In some embodiments the sample is illuminated with halogen light and radiation is detected and imaged at the spectral region of 5-8 μm.

In some embodiments the sample is illuminated with halogen light and radiation is detected and imaged at the spectral region of 8-15 μm, at times at the spectral region of 8-12 μm, even at times at the spectral region of 7-14 μm.

In some embodiments the sample is illuminated with halogen light and radiation is detected and imaged at the spectral region of 12-20 μm.

The detector operable to sense, in its field of view, reflection and/or transmission in the wavelength region within 0.75-20 μm, including wavelength regions of 0.75-5 μm, 1-5 μm, 1-3 μm, 3-5 μm, 5-8 μm, 8-15 μm, 8-12 μm, 7-14 μm and 12-20 μm may be any of those known in the art. Non limiting examples of such detectors include the Indium Gallium Arsenide (in GaAs) detector, a silicon detector, a Vanadium Oxide bolometer as well as an InSb detector.

The IR image obtained in the methods according to the present disclosure may be processed by a dedicated image processing utility into an output indicative of the presence of a microorganism in the imaged sample. The output may be in the form of an image to be display on a suitable display unit, e.g. a monitor, for visual inspection and decision making by a user, the output may be an out print presenting one or more parameters of the sample indicative of the presence (or not) of microorganisms in the sample; and/or the output may be in the form of a yes/no answer indicating if microorganisms are present, or not, respectively, in the imaged sample. For example, an algorithm may be used to determine that when a detected spot is greater than a predefined threshold then the sample may be considered as containing microorganisms.

Image processing may make use of image contrast analysis, edge detection, image arithmetic, cross correlation between images, convolution between images or between an image to a predefined kernel, spatial frequency transformation and/or spatial filtering methods, temporal frequency transformation and temporal filtering methods, Fourier transforms, discrete Fourier transforms, discrete cosine transforms, morphological image processing, finding peaks and valleys (low and high intensity areas), image contours recognition, boundary tracing, line detection, texture analysis, histogram equalization, image deblurring, cluster analysis etc., all as known to those versed in the art of image processing.

In some embodiments the image processing may be performed using MATLAB (The Mathworks, Inc) software. As appreciated, any image or signal processing algorithm known in the art may be equally applied in the context of the present invention. The analysis may be in the spatial domain or time domain or both.

The methods according to the present disclosure may comprise determination based on a combination of images. A first image may be processed by combining the IR image in the spectral range selected from NIR, SWIR, MWIR, LWIR, VLWIR or combination of the same with one or more images obtained in other wavelength ranges such as the visible (VIS) range, using for example a CCD camera, as well as in the ultra violate (UV) range, using UV detectors. The result of combination may be provided as a fusion of such images, e.g. by superposition two or more images one on top of the other, or the combination may result in a value taking into consideration the processing of the different images. Fusion of images may be fusion of the whole images or of selected part/s of the images.

As shown in the following examples, the methods disclosed herein, particularly when making use of the SWIR range for detection, allowed for a rapid and highly sensitive method for detecting microorganisms in a sample. As such, the methods according to the present disclosure may be utilized to determine the presence of microorganisms in an inspected sample e.g., shortly after plating the sample on a Petri dish, or in other words, at relatively early stages of propagation. In some embodiments the methods of the present disclosure allow detection of the presence of microorganisms in the sample after several hours, such as 3 or 2 or even one hour. At times, the detection is even possible after less than an hour, even several minutes (e.g. 10 min.) after placing the sample on a suitable carrier such as a Petri dish or test tube. Early detection of microorganisms and in particular pathogens, has a clear advantage in allowing the providence of early treatment to a subject from which the tested (infected) sample has been obtained, or, on the other hand, avoid a treatment that would have been provided to the subject, in error.

Further, due to the sensitivity of the methods disclosed herein, time-sequential images may be acquired to allow detection of reproducibility of the microorganisms. For example, a parameter indicative of the amount of microorganism in the sample is determined and an increase in the parameter between the sequential images is indicative that the bacteria is replicating in the sample or on the media. To this end, the methods of the present disclosure comprises repeating the step of image acquisition at once, with a time interval between the two image acquisition steps sufficient to allow the microorganism in the tested sample to multiply or reproduce, if such microorganism is reproducible, wherein an increase in the parameter of amount is indicative that the bacteria is replicating.

The parameter indicative of the amount of microorganism in the sample may be obtained by comparing one or more of the size, amount and intensity of light reflected and/or transmitted from the sample with a pre-determined scale of amounts.

The detection according to the present disclosure may be of microorganisms nucleation sited as well as colonies of microorganisms or any other form thereof.

In some further embodiments the methods of the present disclosure may be used to identify the type of microorganism present in the detected sample. To this end, the identification of the microorganism may be determined from the growth rate and/or from the growth pattern which are characteristic to the microorganism. For example, the growth of specific bacterial colonies may have a unique pattern or morphology viewed in the IR image e.g., as elongated pattern, spread pattern, amorphous pattern and the like. Further, as bacterial/microorganism growth has a characteristic rate, the identity of the detected bacterial may be determined by determining the growth rate of the bacteria. To this end, the methods may be configured to correlate between the various images acquired at various time points and the growth rate.

In view of the relatively fast detection of microorganisms in the methods according to the present disclosure the methods may assist in fast determination of the identity of the detected microorganism by combining the methods with other techniques capable of identifying microorganisms e.g., microscopy. In this connection, the methods according to the present disclosure provides the specific location/coordinates of a microorganism in a detected sample and/or the specific location of a microorganism in a sample screened out of a great number of inspected samples. The detected sample may then be further analyzed with other known techniques such as a light microscopy to determine the identity of the detected microorganisms. The advantage of the methods according to the present disclosure may be appreciated considering the great number of samples often being screened for presence of microorganisms out of which only few actually contain a microorganism which determining the identity thereof is of interest.

In identifying the detected microorganisms, the methods may further comprise “spectral imaging” of the sample, the spectral imaging may be characteristic of the detected microorganisms e.g., having a specific image “coloring” for each microorganism. Such imaging techniques are known in the art and may be incorporated in the methods according to the present disclosure.

Following is a list of some non-limiting microorganisms which may be detected and/or identified by the methods of the present invention:

Protozoas: Acanthamoeba; Balantidium coli; Blastocystis; Ctypiosporidium; Cyclospora cayetanensis; Entamoeba histolytica; Giardia intestinalis; Isospora belli; Microsporidia; Naegleria fowleri; Toxoplasma gondii.

Bacteria: Acetobacter Melanogenus; Acinetobacter; Actinomyces israelii; Aeromonas; Alkaligenes; Bacillus; Brucella; Burkholderia; Campylobacter; Cardiobacterium; Chlamydia; Clostridium; Coxiella burnetii; Enterobacter sakazakii; Enteroccous; Erwina aroideae; Escherichia coli; Helicobacter; Klebsiella; Legionella; Leptospira; Listeria monocytogenes; Moraxella; Mycobacterium; Naegleria fowleri; Non-neberculous mycobacteria; Pasteurella pestis (plague): Pseudomonas; Rickettsia; Salmonella; Serratia; Shigella; Staphylococcus; Streptococcus; Tsukamurella; Tularemia; Vibrio cholerae; Yersinia enterocolitica; and subspecies of each.

In some embodiments the bacteria is aerobic. In another embodiment the bacteria is an anaerobic bacteria.

In some embodiments the bacteria is a Gram-negative bacteria. In a specific embodiment the bacteria is from the Enterobacteriaceae family e.g. the anaerobic Escherichia coli (E. coli) bacteria.

In some embodiments the bacteria is the anaerobic Staphylococcus aureus bacteria.

In some embodiments the bacteria is the aerobic Pseudomonas aeruginosa bacteria.

Fungi: Absidia corymbifera; Acremonium spp.; Alternaria alternate; Aspergillis spp.; Aureobasidium pullulans; Blastomyces dermatiitidis; Botrytis cinera; Chaetomium globosum; Cladosporium spp.; Coccidioides immitis.

In some embodiments the fungi is Candida albicans.

The methods of the present disclosure may be used in various fields, including in the medicinal field, the industrial field and product quality assessment etc.

In the medical field, the methods may be utilized in microbial tests, such as in throat swab cultures, blood tests, urine tests and others.

In other embodiments the methods of the present disclosure may be utilized to detect microorganisms in a product, e.g. a food product, a drug, a cosmetic product, a personal care product and the like.

For example, when referring to food products typical bacterial contaminations include, without being limited thereto Campylobacter jejuni, Clostridium botulinum, Escherichia coli, Salmonella typhimurium, Shigella, Staphylococcus aureus, Vibrio cholera, Vibrio vulnificus, Lactococcus cremoris, Enterobacter aero-genes, E. coli, Clostridium perfringens and enterococci. Further, when referring to food products, typical parasites contaminations include without being limited thereto Entamoeba histolytica, Giardia duodenalis, Cryptosporidium parvum, Cyclospora cayetanesis, Toxoplasma gondii, Trichinella spiralis, Taenia saginatajsolium, Taenia saginata, and Taenia solium.

When referring to drugs, these may be contaminated, with various microorganisms. For example, anesthetic drugs, such as propofol, midazolam, thiopentone are prone to contaminations with coagulase-negative staphylococci.

In this connection, the methods according to the present disclosure may also be utilized in a manufacturing process of a product, e.g. for quality assurance.

In some embodiments the methods according to the present disclosure may be utilized to determining the efficiency of an anti-microbial agent (e.g., antibacterial agent, anti fungous agent) against a microorganism. To this end, the sample tested in the methods according to the present disclosure comprises an anti-microbial agent and a predetermined amount of microorganisms. The growth/presence of the microorganisms is inspected by imaging at various time points the radiation reflected and/or transmitted therefrom, at times with illumination of the sample as detailed herein above. The amount of microorganisms and/or the growth rate of the microorganisms may be determined as detailed hereinabove and may be indicative of the efficacy of the anti-microbial agent present in the sample against the microorganisms. For example, reduction in the number of microorganisms compared to a control sample (without anti-microbial agent), being exhibited by reduced radiation imaged on the IR image, may be indicative of antimicrobial activity of the tested agent. In some embodiments the inspected sample may constitute both the test and the control sample e.g., the sample may by an agar Petri dish comprising microorganisms (applied thereto for example by spreading) wherein pert of the dish (e.g., half of it) is introduced (e.g., be spreading, dripping, spraying and the like) with an anti-microbial agent and part of it (the other half) remains clear of anti-microbial agent. Imaging the radiation reflected and/or transmitted from the sample (with or without illumination) at various time points may provide a comparative result between the control part of sample and the part exposed to anti-microbial agent (i.e., the part in which the microorganisms were brought into contact with the anti-microbial agent), the comparison being indicative of the efficacy of the agent against microorganisms.

Thus, the methods according to the present disclosure may be utilized for screening of new anti-microbial drugs e.g., antibacterial drugs and anti fungous drugs.

Accordingly, the present disclosure provides in accordance with yet a further aspect, a method of determining the efficiency of an anti-microbial agent against a microorganism, the method comprises:
providing at least two samples comprising a microorganism against which the efficiency of an agent is to be determined, at least one of the at least two samples being a control sample and at least one of the at least two samples being a test sample;
contacting the test sample with an amount of an agent; and
generating one or more IR images of each sample using an IR detector operable to detect in its field of view, radiation reflected and/or transmitted from the test sample in a spectral region within 0.75 to 20 μm, wherein a difference between the one or more IR images of the test sample and the one or more IR images of the control sample being indicative that the agent affects the microorganism.

In accordance with yet a further aspect the present disclosure provides a method of determining the efficiency of an anti-microbial agent against a microorganism, the method comprises:
providing at least two samples comprising a microorganism against which the efficiency of an agent is to be determined, at least one of the at least two samples being a control sample and at least one of the at least two samples being a test sample;
contacting the test sample with an amount of an agent; and
generating one or more IR images of each sample using an IR detector operable to detect, in its field of view, radiation reflected and/or transmitted from the test sample in a spectral region selected from 0.75-5 μm, 5-8 μm, 8-12 μm, 12-20 μm and a combination of the same, wherein a difference between the one or more IR images of the test sample and the one or more IR images of the control sample being indicative that the agent affects the microorganism.

Further, in accordance with another aspect the present disclosure provides a method of determining the efficiency of an anti-microbial agent against a microorganism, the method comprises:
providing at least two samples comprising a microorganism against which the efficiency of an agent is to be determined, at least one of the at least two samples being a control sample and at least one of the at least two samples being a test sample;
contacting the test sample with an amount of an agent;
illuminating the at least two samples; and
generating one or more IR images of each sample using an IR detector operable to detect, in its field of view, radiation reflected and/or transmitted from the test sample in a spectral region within 0.75 to 20 μm, wherein a difference between the one or more IR images of the test sample and the one or more IR, images of the control sample being indicative that the agent affects the microorganism.

In accordance with yet a further aspect the present disclosure provides a method of determining the efficiency of an anti-microbial agent against a microorganism, the method comprises:
providing at least two samples comprising a microorganism against which the efficiency of an agent is to be determined, at least one of the at least two samples being a control sample and at least one of the at least two samples being a test sample;
contacting the test sample with an amount of an agent;
illuminating the at least two samples; and
generating one or more IR images of each sample using an IR detector operable to detect, in its field of view, radiation reflected and/or transmitted from the test sample in a spectral region selected from 0.75-5 μm, 5-8 μm, 8-12 μm, 12-20 μm and a combination of the same, wherein a difference between the one or more IR images of the test sample and the one or more IR images of the control sample being indicative that the agent affects the microorganism.

In accordance with yet a further aspect the present disclosure provides a method of determining the efficiency of an anti-microbial agent against a microorganism, the method comprises:
providing at least two samples comprising a microorganism against which the efficiency of an agent is to be determined, at least one of the at least two samples being a control sample and at least one of the at least two samples being a test sample;
contacting the test sample with an amount of an agent;
illuminating the at least two samples; and
generating one or more IR images of each sample using an IR detector operable to detect, in its field of view, radiation reflected and/or transmitted from the test sample in a spectral region of 1-5 μm, wherein a difference between the one or more IR images of the test sample and the one or more IR images of the control sample being indicative that the agent affects the microorganism.

Thus, in the context of the above methods, a difference between the one or more IR images of the test sample and the one or more IR images of the control sample being indicative that the agent affects the microorganism may be exhibited by a lower radiation imaged in the IR image(s) of the test sample as compared to those of the control sample.

Notably, while typically the control sample is a sample without the agent, at times, the methods disclosed above may be for determining dose efficacy of an agent. As such, all microorganism containing samples may be treated with the agent, however with different, e.g. escalating, dosages.

In some embodiments the radiation reflected and/or transmitted from the sample (test and control sample) is in the spectral region of 0.75-1.4 μm.

In some embodiments the radiation reflected and/or transmitted from the sample is in the spectral region of 1-3 μm.

In some embodiments the radiation reflected and/or transmitted from the sample is in the spectral region of 1.4-3 μm, at times in the spectral region of 1-1.7 μm.

In some embodiments the radiation reflected and/or transmitted from the sample is in the spectral region of 1-5 μm.

In some embodiments the radiation reflected and/or transmitted from the sample is in the spectral region of 3-5 μm.

In some embodiments the radiation reflected and/or transmitted from the sample is in the spectral region of 5-8 μm.

In some embodiments the radiation reflected and/or transmitted from the sample is in the spectral region of 8-15 μm, at times in the spectral region of 8-12 μm or 7-14 μm.

In some embodiments the radiation reflected and/or transmitted from the sample is in the spectral region of 12-20 μm.

In some embodiments the difference between the one or more IR images of the test sample and the one or more IR images of the control sample, may be in a parameter indicative of the amount of microorganism in the samples, such that a lower amount of microorganism in the test sample being indicative that the agent has an anti-microbial effect e.g. antibacterial effect.

The aforementioned methods of determining the efficiency of an anti-microbial agent against a microorganism may be utilized for screening of new anti-microbial drugs such as antibacterial drugs.

It is noted that certain embodiments of the invention which are described in the context of one aspect may be applicable in other aspects of the invention.

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1 shows a visible (VIS) image of an agar Petri dish spread with an E. coli bacteria.

FIGS. 2A-2B show IR images of an agar Petri dish spread with an E. coli bacteria detected at a spectral region of 1-5 μm. The images were acquired three hours after the bacteria was spread on the Petri dish (FIG. 2A) and after overnight growth of the bacteria (FIG. 2B), while illuminating the dish with a red IR heat lamp (100 Watt).

FIGS. 3A-3B show FR images of an agar Petri dish spread with an Aureus bacteria detected at a spectral region of 1-5 μm. The images were acquired two hours after the bacteria was spread on the Petri dish (FIG. 3A) and after overnight growth of the bacteria (FIG. 3B), while illuminating the dish with a red IR heat lamp (100 Watt).

FIGS. 4A-4B show IR images of an agar Petri dish spread with an Aeruginosa bacteria detected at a spectral region of 1-5 μm. The images were acquired three hours after the bacteria was spread on the Petri dish (FIG. 4A) and after overnight growth of the bacteria (FIG. 4B), while illuminating the dish with a red IR heat lamp (100 Watt).

FIGS. 5A-5B show IR images of an agar Petri dish spread with an Albicans fungi detected at a spectral region of 1-5 μm. The images were acquired three hours after the bacteria was spread on the Petri dish (FIG. 5A) and after overnight growth of the bacteria (FIG. 5B), while illuminating the dish with a red IR heat lamp (100 Watt).

### DESCRIPTION OF SOME NON-LIMITING EXAMPLES

### Example 1

### Illumination and Imaging of Bacterial and Fungous Samples at VIS Spectral Region

Bacterial samples of Escherichia coli (E. coli), Aureus and Aeruginosa and a fungi sample of Albicans were each individually spread on an agar Petri dish. VIS images of the dishes were acquired using a CCD camera at various time points: immediately after spreading, after 1 hour, after 2 hours and after 3 hours.

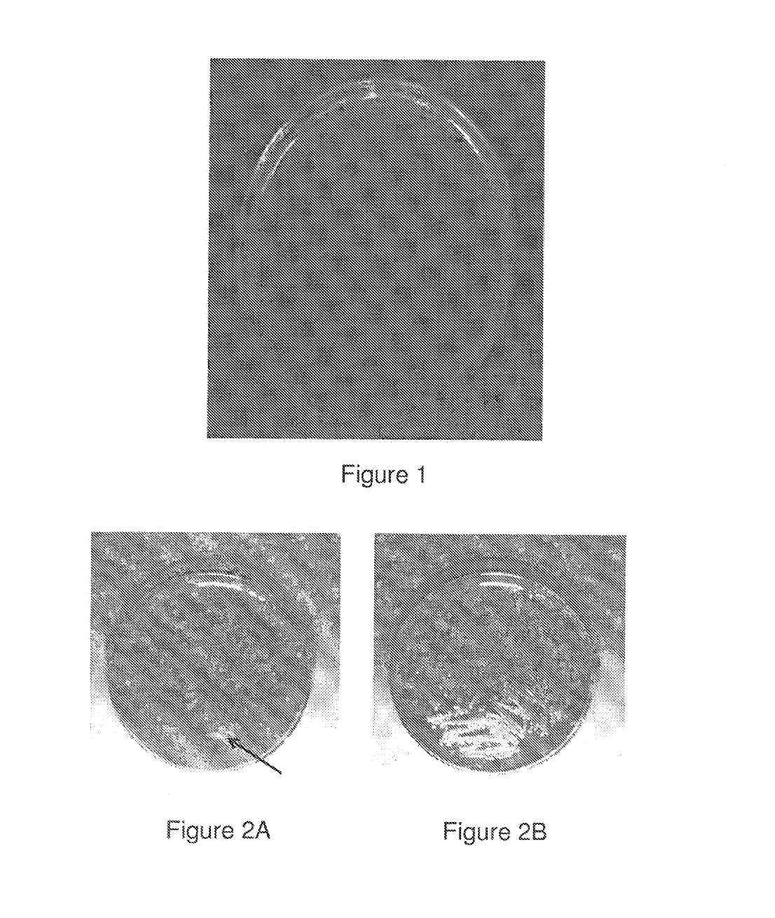

FIG. 1 shows a visible image of an agar Petri dish spread with E. coil bacteria. The image was taken two hours after the spreading of the bacteria at room temperature. The image was acquired while illuminating the sample with a red/infrared heat lamp (100 Watt) and while the Petri dish was placed on a Black body radiation source with a temperature controller set to 15° C. It is clear from FIG. 1 that the presence of the E. coli bacteria on the Petri dish cannot be detected from the acquired VIS image. Similar results were observed while acquiring the visible image three hours after the spreading of the bacteria. The same results were obtained with Aureus and Aeruginosa bacteria as well as with Albicans fungi (data not shown).

### Example 2

### IR Imaging of Bacterial and Fungous Samples at Spectral Regions of 1-5 μm And 8-12 μm

Bacterial samples of Escherichia coli (E. coli), Aureus and Aeruginosa and a fungi sample of Albicans were each individually spread on an agar Petri dish. Infrared images of the dishes (without illumination thereof) were acquired at room temperature using an IR camera equipped with IR detectors at the spectral ranges of 1-5 μm (a cooled InSb IR detector) and 8-12 μm (an un-cooled VOx detector), at various time points: immediately after spreading, after 1 hour and after 2 hours.

The presence of bacteria or fungi on the Petri dishes was not detected from the images (data not shown).

### Example 3

### Illumination and IR Imaging of Bacterial and Fungous Samples at a Spectral Region of 3-5 μm

Bacterial samples of Escherichia coli (E. coli), Aureus and Aeruginosa and a fungi sample of Albicans were each individually spread on an agar Petri dish. The Petri dishes were placed on a Black body radiation source with a temperature controller set to 15° C. and illuminated with a red/infrared heat lamp (100 Watt). During illumination images of the Petri dish were acquired using an IR camera equipped with a cooled InSb IR detector at the spectral range of 3-5 μm. The images were acquired at various time points: at zero point immediately after spreading on the agar Petri dish, 1 hour after the spreading and 2 hours after the spreading and keeping the samples at room temperature. It is noted that the samples were illuminated only while acquiring the IR images.

From the IR images colonies of bacteria and fungi on the agar were detected (data not shown).

### Example 4

### Illumination and IR Imaging of Bacterial and Fungous Samples at a Spectral Region of 1-5 μm

Bacterial samples of Escherichia coli (E. coli), Auresus and Aeruginosa and a fungi sample of Albicans were each individually spread on an agar Petri dish. The Petri dishes were illuminated with a red IR heat lamp (100 Watt) after spreading and while illuminating; images of the dishes were acquired (at room temperature) using an IR camera equipped with an IR detector at the spectral range of 1-5 μm (a cooled InSb IR detector). Images were acquired at various time points, including, at zero point immediately after spreading on the agar Petri dish, 1 hour after the spreading, 2 hours after the spreading and 3 hours after the spreading. Images were also acquired after the spread dishes were left over night at room temperature. It is noted that the samples were illuminated only while acquiring the IR images.

Colonies of bacteria and fungi on the agar were clearly detected, at high resolution level, in the images of the IR camera, even 1 hour after beginning of spreading the bacteria on the dish.

FIGS. 2A-2B show IR images of an agar Petri dish spread with an E. coli bacteria detected at a spectral region of 1-5 μm. The images were acquired while illuminating the sample with a red/infrared heat lamp. The image presented in FIG. 2A was taken three hours after the bacteria were spread on the Petri dish. The image presented in FIG. 2B was taken after overnight growth of the bacteria. Colonies of E. coli can be clearly detected in FIGS. 2A-2B. It is noted that colonies can be clearly detected even only after three hours growth of the bacteria; the detected colonies are indicated by the arrow in FIG. 2A.

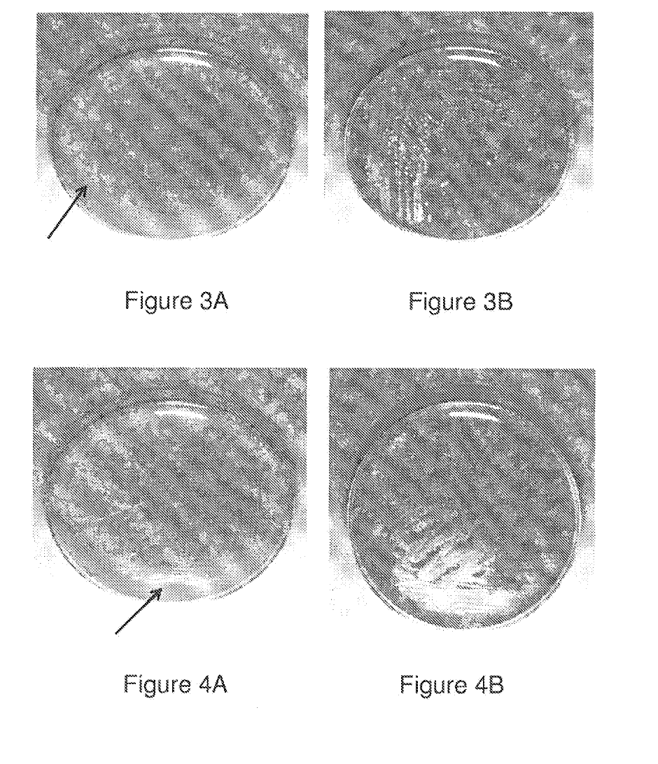

FIGS. 3A-3B show IR images of an agar Petri dish spread with an Aureus bacteria detected at a spectral region of 1-5 μm. The images were acquired while illuminating the sample with a red/infrared heat lamp. The image presented in FIG. 3A was taken two hours after the bacteria were spread on the Petri dish. The image presented in FIG. 3B was taken after overnight growth of the bacteria. Colonies of Aureus can be clearly detected in FIGS. 3A-3B. It is noted that colonies can be clearly detected even only after two hours growth of the bacteria; the detected colonies are indicated by the arrow in FIG. 3A.

FIGS. 4A-4B show IR images of an agar Petri dish spread with an Aeruginosa bacteria detected at a spectral region of 1-5 μm. The images were acquired while illuminating the sample with a red/infrared heat lamp. The image presented in FIG. 4A was taken three hours after the bacteria were spread on the Petri dish. The image presented in FIG. 4B was taken after overnight growth of the bacteria. Colonies of Aeruginosa can be clearly detected in FIGS. 4A-4B. In it noted that colonies can be clearly detected even only after three hours growth of the bacteria; the detected colonies are indicated by the arrow in FIG. 4A.

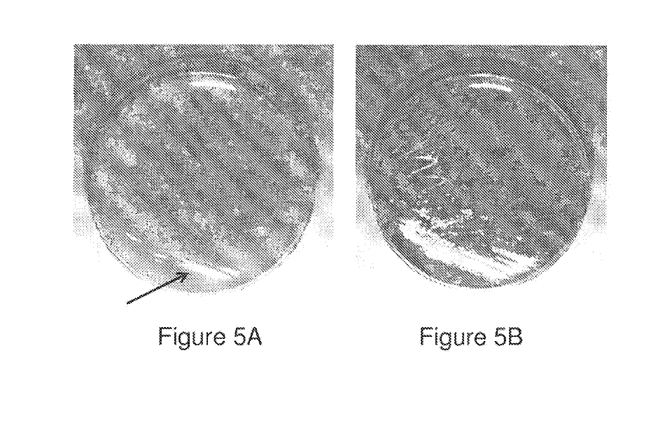

FIGS. 5A-5B show IR images of an agar Petri dish spread with an Albicans fungi detected at a spectral region of 1-5 μm. The images were acquired while illuminating the sample with a red/infrared heat lamp. The image presented in FIG. 5A was taken three hours after the fungi were spread on the Petri dish. The image presented in FIG. 5B was taken after overnight growth of the fungi. Colonies of Albicans can be clearly detected in FIGS. 5A-5B. In it noted that colonies can be clearly detected even only after three hours growth of the fungi; the detected colonies are indicated by the arrow in FIG. 5A.

### Example 5

### Illumination and IR Imaging at a Spectral Region of 1-5 μm of Bacterial and Fungous Samples Cooled to 15° C.

Bacterial samples of Escherichia coli (E. coli), Auresus and Aeruginosa and a fungi sample of Albicans were each individually spread on an agar Petri dish. After one hour the Petri dishes were placed in a cooling chamber at 15° C. The cooled Petri dish samples were placed at room temperature and immediately illuminated with a red IR heat lamp (100 Watt) and images of the dishes were acquired, using an IR camera equipped with an IR detector at the spectral range of 1-5 μm (a cooled InSb IR detector).

Colonies of bacteria and fungi on the agar were detected at high resolution level with clear contrast between the bacterial/fungi growth sites and the rest of the Petri dish area were no growth occurred (data not shown).

The Examples provided herein show that no detection of illuminated bacteria or fungi was accomplished at the visible spectral region, nor detection was possible by IR imaging at 1-5 μm and 8-12 μm IR regions when the bacteria or fungi were not illuminated. Imaging of microorganisms at 3-5 μm was effective when illuminating the samples.

Furthermore, high resolution imaging was possible when images were acquired at the range of 1-5 μm when illuminating the samples. These high resolution images were obtained even after 1 hour of culturing of the microorganisms.

Without being bound by theory, it is assumed by the inventors that imaging in the range of 1-3 μm contributes to the significant increase in resolution of the images acquired at the range of 1-5 μm (as compared to images in the range from 3-5 μm).

1. A method of detecting the presence of a microorganism in a tested sample, the method comprises:
illuminating the tested sample; and
generating one or more infrared (IR) images of the sample using an IR detector operable to detect, in its field of view, radiation reflected and/or transmitted from the test sample in the IR spectral region of 0.75 to 20 μm or spectral region therein;
wherein said radiation, imaged in the one or more IR images, is indicative of the presence of a microorganism in the test sample.

2. The method according to claim 1, wherein said reflected radiation is detected in a spectral region selected from the groups consisting of 0.75-5 μm, 5-8 μm, 8-12 μm and 12-20 μm.

3. The method according to claim 1, wherein the spectral region is selected from the group consisting of 0.75-1.4 μm, 1-3 μm, 1.4-3 μm, 1-1.7 μm, 1-5 μm, 3-5, 5-8 μm, 8-12 μm, 7-14, 8-15 μm and 12-20 μm.

4. The method according to claim 1, wherein the spectral region is 1-5 μm.

5. The method according to claim 1, wherein the spectral region is 1-3 μm.

6. The method according to claim 1, wherein the illumination is by one or more light sources selected from the group consisting of halogen light, ultra violate light, visible light and infrared light.

7. The method according to claim 1, wherein imaging is performed at ambient temperature or below.

8. The method according to claim 1, wherein said microorganism is selected from the group consisting of bacterium, fungus, archaea, protists, prion, protozoa, spores and virus.

9. A method of determining the efficiency of an anti-microbial agent against a microorganism, the method comprises:
providing at least two samples comprising a microorganism against which the efficiency of an agent is to be determined, at least one of the at least two samples being a control sample and at least ore of the at least two samples being a test sample;
contacting the test sample with an amount of an agent;
illuminating the at least two samples; and
generating one or more IR images of each sample using an IR detector operable to detect, in its field of view, radiation reflected and/or transmitted from the test sample in a spectral region within 0.75 to 20 μm, wherein a difference between the one or more IR images of the test sample and the one or more IR images of the control sample being indicative that the agent affects the microorganism.

10. The method according to claim 9, wherein said reflected radiation is detected in a spectral region selected from the groups consisting of 0.75-5 μm, 5-8 μm, 8-12 μm and 12-20 μm.

11. The method according to claim 9, wherein the spectral region is selected from the group consisting of 0.75-1.4 μm, 1-3 μm, 1.4-3 μm, 1-1.7 μm, 1-5 μm, 3-5, 5-8 μm, 8-12 μm, 7-14, 8-15 μm and 12-20 μm.

12. The method according to claim 9, wherein the spectral region is 1-5 μm.

13. The method according to claim 9, wherein the spectral region is 1-3 μm.

14. The method according to claim 9, wherein the illumination is by one or more light sources selected from the group consisting of halogen light, ultra violate light, visible light and infrared light.

15. The method according to claim 9, wherein imaging is performed at ambient temperature or below.

16. The method according to claim 9, wherein said microorganism is selected from the group consisting of bacterium, fungus, archaea, protists, prion, protozoa, spores and virus.
